(19) United States
(12) Patent Application Publication
(10) Pub. No.: US 2013/0132292 A1
(43) Pub. Date: May 23, 2013

(54) METHOD AND APPARATUS FOR PROVIDING ENHANCED CONSUMER PRODUCT INFORMATION

(71) Applicants: Michael Lamb, Rancho Santa Fe, CA (US); Michael Bailey, Carlsbad, CA (US); Carlo Q. Petrucci, Woodbridge (CA); Jason G. Konkoly, Chula Vista, CA (US); Thomas Thibault, San Diego, CA (US); Brandon Gruber, Vista, CA (US)

(72) Inventors: Michael Lamb, Rancho Santa Fe, CA (US); Michael Bailey, Carlsbad, CA (US); Carlo Q. Petrucci, Woodbridge (CA); Jason G. Konkoly, Chula Vista, CA (US); Thomas Thibault, San Diego, CA (US); Brandon Gruber, Vista, CA (US)

(73) Assignee: Ecolink Intelligent Technology, Inc

(21) Appl. No.: 13/303,971

(22) Filed: Nov. 23, 2011

(51) Int. Cl. G06Q 30/00

(52) U.S. Cl. 705/318

(57) ABSTRACT

A method and apparatus for providing enhanced product information is disclosed. In one embodiment, the method comprises receiving consumer product identification information relating to the consumer product from an electronic tag co-located with the consumer product, sending an information request to a remote server, the information request comprising the consumer product identification information, receiving the enhanced product information from the remote server, the enhanced product information comprising information relating to the consumer product, and displaying the enhanced product information on an electronic display.

### BACKGROUND

I. Field of Use

The present application relates to the field of retail merchandise and marketing.

More specifically, the present application relates to a method and apparatus for providing enhanced consumer product information to consumers.

II. Description of the Related Art

The importation and sale of counterfeit goods has been a problem for many years. Certain consumer goods, especially very expensive or desirable brands, or those that are easy to reproduce cheaply, have become frequent and common targets of counterfeiting. The counterfeiters either attempt to deceive the consumer into thinking they are purchasing a legitimate item, or convince the consumer that they could deceive others with the imitation. High-end retail clothing and accessories has been particularly exploited. It is becoming increasingly easy for sophisticated counterfeiters to produce high-quality reproductions that include widespread anti-counterfeit measures, such as holograms or elaborate packaging.

Counterfeiting is not only a problem for manufacturers, but for consumers as well. Many consumers would like to know, definitively, whether the products they purchase are authentic. In addition, consumers may want to electronically register an affirmation that they have, indeed, purchased a particular consumer product and/or receive details about the consumer product that they have purchased (or are about to purchase) that may not be available on the product packaging or are otherwise readily available.

Thus, it would be desirable to offer consumers a way to ensure that they products they purchase are genuine, to provide an electronic registration process, and to provide additional product information to consumers who desire such information.

### SUMMARY

The embodiments described herein relate to a method and apparatus for providing enhanced consumer product information. In one embodiment, the method comprises receiving consumer product identification information relating to the consumer product from an electronic tag co-located with the consumer product, sending an information request to a remote server, the information request comprising the consumer product identification information, receiving the enhanced product information from the remote server, the enhanced product information comprising information relating to the consumer product, and displaying the enhanced product information on an electronic display.

In another embodiment, an apparatus for providing enhanced consumer product information comprises a receiver for receiving consumer product identification information relating to the consumer product from an electronic tag co-located with the consumer product, a transceiver for transmitting and receiving information, a processor, and a memory for storing processor-readable instructions that cause the apparatus to: transmit an information request to a remote server using the transceiver, the information request comprising the consumer product identification information, and receive the enhanced product information from the remote server, the enhanced product information comprising information relating to the consumer product, and a user interface for displaying the enhanced product information.

In yet another embodiment, a method for providing enhanced consumer product information comprises receiving the enhanced product information from a source of the consumer product, storing the enhanced product information in a memory, receiving an information request from a wireless communication device, the information request comprising consumer product identification information relating to the consumer product, the consumer product identification information provided by an electronic tag co-located with the consumer product, comparing the consumer product identification information to the enhanced product information stored in the memory, and sending the enhanced product information to the wireless communication device if a match if found between the consumer product identification information and the enhanced product information.

In still yet another embodiment, an apparatus for providing enhanced consumer product information comprises a network interface for sending and receiving information, a processor, a memory for storing the enhanced product information and processor-readable instructions that cause the apparatus to: receive an information request from a wireless communication device, the information request comprising consumer product identification information relating to the consumer product, the consumer product identification information provided by an electronic tag co-located with the consumer product, compare the consumer product identification information to the enhanced product information stored in the memory, and send the enhanced product information to the wireless communication device if a match if found between the consumer product identification information and the enhanced product information.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is an illustration of a system for providing enhanced consumer product information to consumers;

FIG. 2 is a functional block diagram illustrating one embodiment of wireless communication device used in the system shown in FIG. 1;

FIG. 3 is a functional block diagram illustrating one embodiment of a server used in the system of FIG. 1;

FIG. 4 is a flow diagram illustrating one embodiment of a method for providing enhanced product information, implemented to the wireless communication device shown in FIG. 1; and

FIG. 5 is a flow diagram illustrating another embodiment of a method for providing enhanced product information, implemented by the server shown in FIG. 1.

### DETAILED DESCRIPTION

The present description relates to an apparatus and method for providing enhanced consumer product information to consumers. In one embodiment, an electronic tag is co-located with a consumer product, such as a shoe, shirt, pants, handbag, etc. during the manufacturing stage. The electronic tag may be used by a consumer as a basis of providing enhanced consumer product information to the consumer, such as the authenticity of the consumer product either before or after purchasing the product, registration information, and/or additional product information. In one embodiment, once a consumer product has been authenticated as being genuine, registration and/or other product information may be provided to/from a software application executed on a mobile communication device. Enhanced product information may comprise a date that a particular consumer product was manufactured, shipped, sold, etc., series information relating to the total number of the same product type manufactured or sold and a particular product's number in the series, a visual representation of the product (i.e., a digital image of the product, a video of the product), a visual representation of people, places, or things related to the product, such as a video showing places of interest in a city where the product was manufactured, or where the headquarters of the product is located, a video of a celebrity wearing or using the product), a list of celebrities who have previously authenticated/registered the product, information related to similar products (e.g., description of similar items, price, location, etc), a description of similar products that others have purchased, one or more visual examples of the product used in conjunction with related products (e.g., if the product is shoes, providing an image or video of a model wearing the shoes plus pants and shirt selected to coordinate with the shoes), future notices related to the product (such as a recall, the availability of a new style, the availability of the product or a similar product at a predetermined price, etc), and other information related to either the particular product in question, or information relating to the product in general.

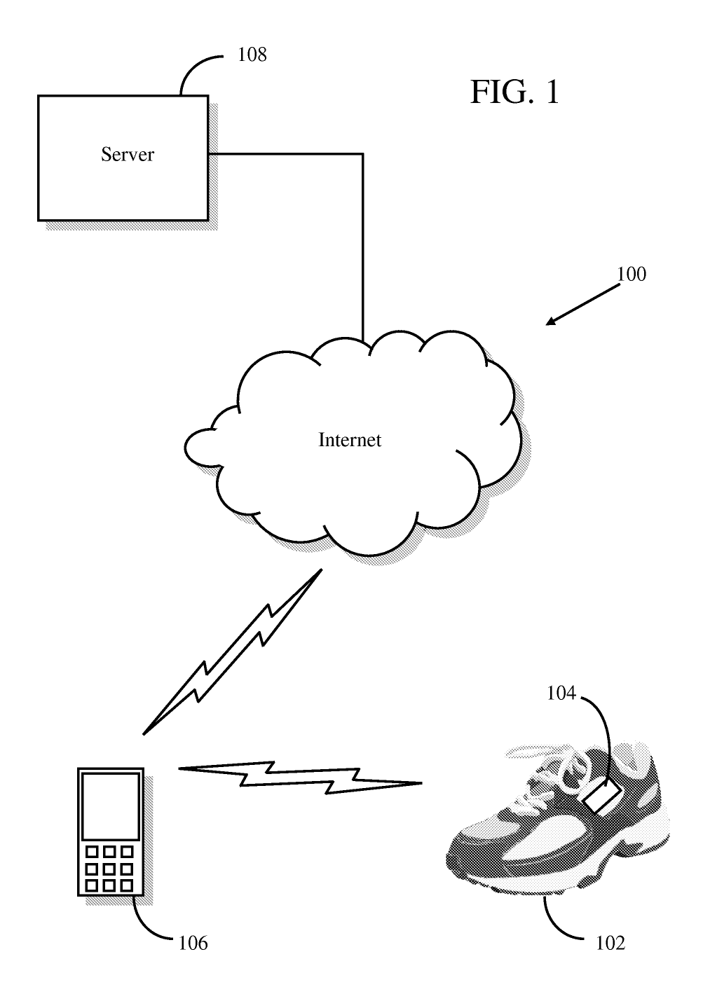

FIG. 1 is an illustration of a system 100 for providing enhanced consumer product information to consumers. Shown is consumer product 102, tag 104, wireless communication device 106, and server 108. Consumer product 102, in this embodiment, comprises a shoe, but in other embodiments, could comprise virtually any product, such as clothing, books, electronic devices, handbags, hats, toys, appliances, etc.

Consumer product 102 comprises an electronic tag, transponder, marker, bar code, a memory device, a magnetic device, an RF transmitter, or any other device that is able to provide information about consumer product 102 (herein “tag 104”), which is typically co-located with consumer product 102 (i.e., attached to, built, installed, labeled, stitched, adhered, fastened onto/into consumer product 102), typically during the manufacturing stage. In another embodiment, tag 104 could be attached to or installed into/onto consumer product 102 at some other point after manufacturing, such prior to the point of sale.

In one embodiment, tag 104 comprises an RFID tag. The RFID tag may comprise an active, semi-active, or a passive RFID device that are well-known in the art. These tags can store several thousand bytes of data and are typically composed of a microchip, antenna and, in the case of active and semi-passive tags, a battery. In a typical application, an RFID tag receives electromagnetic energy from an RFID scanner or reader. Then, using power from its internal battery or power harvested from the reader's electromagnetic field, the tag sends radio waves back to the reader that include information stored within the tag. The reader demodulates the tag's radio waves to receive the information stored on the tag.

Passive RFID tags typically rely entirely on the reader as their power source. These tags may be read up to 20 feet away, and they have lower production costs, meaning that they can be applied to less expensive merchandise. These tags are manufactured to be disposable, along with the disposable consumer goods on which they are placed.

In one embodiment, a consumer may wish to know whether a consumer product is authentic and/or to receive enhanced product information before or after purchasing the consumer product. The user may launch a software application resident within wireless communication device 106 that performs these functions in conjunction with technology capable of receiving information from tag 104 within wireless communication device 106. Wireless communication device 106 typically comprises a wireless telephone, cellphone, smartphone, or the like comprising circuitry necessary to receive information from tag 104.

When a consumer is ready receive enhanced product information from consumer product 102, he or she typically holds consumer product 102 in close proximity to wireless communication device 106, whereupon information stored in tag 104 is received wirelessly by wireless communication device 106. The information stored in tag 104 typically comprises information identifying consumer product 102 and/or information used to authenticate consumer product 102, such as a make and/or model number of consumer product 102, a serial number of consumer product 102, one or more attributes of consumer product 102 such as size, color, price, etc., an encrypted digital signature, an encrypted serial number, cryptographic keys, or other information well-known in the art to perform authentication. The information received from tag 104 is then typically transmitted to a remote destination, such as server 108, in the form of an information request by wireless communication device 106 via a data network, such as the Internet. Server 108 receives the information request transmitted by wireless communication device 106 and may provide enhanced product information relating to consumer product 102 back to the consumer in the form of an authentication validation, registration information, and/or other product information, via the Internet and wireless communication device 106. If an authentication procedure is conducted, the result of the procedure indicates whether consumer product 102 is genuine, and an indication of such is sent from server 108 to wireless communication device 106, where the consumer is notified of the authentication result. In one embodiment, registration information and/or other product information is sent only if the authentication process is successful.

Server 108 comprises hardware and software necessary to perform authentication, to register and provide registration information regarding consumer product 102, and to provide enhanced consumer product information when requested by one or more wireless communication devices 106. It also comprises one or more memory devices to store information pertaining to a variety of consumer products. For example, information regarding a particular consumer product may include a date of manufacturer, manufactured series information (i.e., shoe number 10,873 out of a total of 20,000 shoes manufactured), a location of manufacture, and/or a visual image of the consumer product. Information pertaining to the consumer product in general could also be stored. For example, as consumers authenticate similar products (for example, the same consumer product model), server 108 can keep track of how many successful (and/or unsuccessful) authentications have been processed and/or how many times enhanced product information has been requested and/or provided.

Server 108 could also store a list of celebrity names and compare identification information contained in information requests to the list of celebrity names. In this embodiment, the information request comprises identification information that identifies who is requesting the authentication and/or enhanced product information. The name associated with the information request is compared to the list of celebrity names and, if a match is found, a record of the match is stored in memory and associated with the type, or model, of consumer product under consideration. Thus, server 108 tracks the identity of celebrities who have requested product authentication and/or enhanced product information and that information may be provided to consumers who, in turn, submit information requests with regard to the same or similar consumer products.

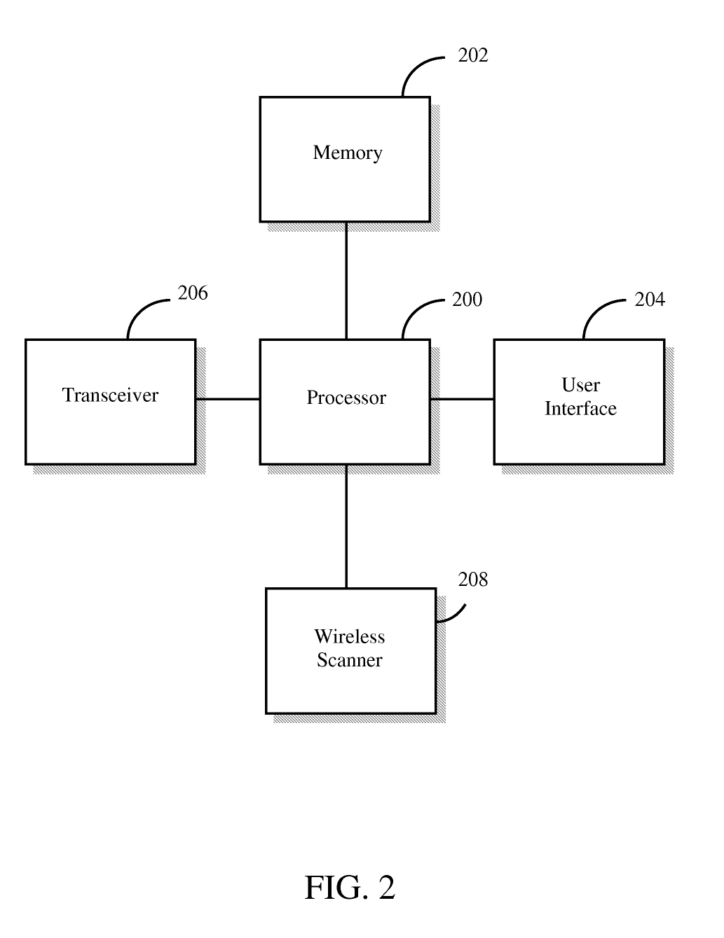

FIG. 2 is a functional block diagram illustrating one embodiment of wireless communication device 106, comprising processor 200, memory 202, user interface 204, transceiver 206, and reader 208. It should be understood that not all of the functional blocks shown in FIG. 2 are required for operation of wireless communication device 106, that the functional blocks may be connected to one another in a variety of ways, and that not all functional blocks necessary for operation of security apparatus 106 are shown (such as a power supply), for purposes of clarity.

Processor 200 is configured to provide general operation of wireless communication device 106 by executing processor-executable instructions stored in memory 202, for example, executable code. Processor 200 typically comprises a general purpose processor, although any one or more of a variety of microprocessors, microcomputers, custom ASICs, discrete components, and/or microcontrollers may be used alternatively.

Memory 202 comprises one or more information storage devices, such as RAM, ROM, EEPROM, UVPROM, flash memory, CD, DVD, Memory Stick, SD memory, XD memory, thumb drive, or virtually any other type of electronic, optical, or mechanical memory device. Memory 202 is used to store the processor-executable instructions for operation of wireless communication device 106 as well as any information used by processor 200. For example, the processor-executable instructions may allow a user of wireless communication device 106 to make and receive wireless telephone calls and to send and receive data. In addition, the processor-executable instructions comprise instructions to operate reader 208 to receive consumer product information from tag 104, to formulate an information request using the information, and to send the information request to server 108. The processor-executable instructions may further comprise instructions for processor 200 to receive a response from server 108 indicating a successful or unsuccessful authentication, and/or to provide enhanced product information to the user via user interface 204.

In one embodiment, the processor-executable instructions may comprise a software application, commonly referred to as an “app,” that may be downloaded by the user from a software repository, such as the popular iTunes store. A user wishing to authenticate consumer product 102 may begin by “launching” the app using user interface 204, i.e., initiating the application.

User interface 204 is coupled to processor 200 and allows a user to operate wireless communication device 106. User interface 204 may comprise one or more pushbuttons, switches, sensors, keypads, and/or microphones that generate electronic signals for use by processor 200 upon initiation by a user. User interface 204 may additionally comprise one or more electronic displays, such as a touchscreen display, a seven-segment display, a cathode ray tube (CRT), a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of information to a user. Of course, the aforementioned items could be used alone or in combination with each other and other devices may be alternatively, or additionally, used.

Transceiver 206 comprises circuitry necessary to transmit and receive wireless communication signals from one or more communication networks, such as cellular telephone networks or high-speed data networks. Such circuitry is well known in the art and may comprise CDMA, GSM, BlueTooth, Wi-Fi, RF, optical, or ultrasonic circuitry, among others.

Reader 208 receives information from tag 104 used to identify, authenticate and/or register consumer product 102. It may comprise an RFID reader, a bar code scanner, RF circuitry, magnetic sensing device, or some other circuitry to detect information held by tag 104. In an embodiment where reader 208 comprises an RFID reader, radio frequency signals are typically transmitted from reader 208, thereby “illuminating” tag 104. Tag 104, in response to the radio frequency signals, transmits information stored thereon, such as a unique serial number, or other information that may uniquely identify consumer product 102 to which it is affixed, and/or information used to authenticate tab 104 and, thus, consumer product 102, such as an encrypted digital signature, an encrypted serial number, cryptographic keys, or other information well-known in the art to perform authentication.

In one embodiment, once consumer product 102 has been authenticated and/or registered, consumer product 102 may be conveniently re-ordered simply by entering a request via the software application resident on wireless communication device 106. For example, the software application could allow a consumer to display an image of any consumer product 102 that the consumer may have authenticated/registered in the past, then, upon selection by the consumer, a screen may be displayed asking the consumer whether he or she would like to re-purchase the selected consumer product. If so, a query may be sent by processor 300 to the Internet to determine one or more current prices of the chosen consumer product and an identification of one or more merchants offering the particular consumer product. In another embodiment, the software application may query one or more websites for current pricing at periodic, or other, time intervals and provide this information to the consumer as the consumer views the consumer product on wireless communication device 106. In either case, the pricing information, as well as merchant identification information, is presented to the consumer, who may choose to re-order the product by providing an acceptance indication to the software application. The acceptance indication is received by processor 300, and then an order is generated and sent to the selected merchant. The order may comprise a quantity of consumer goods, payment information, shipping information, etc.

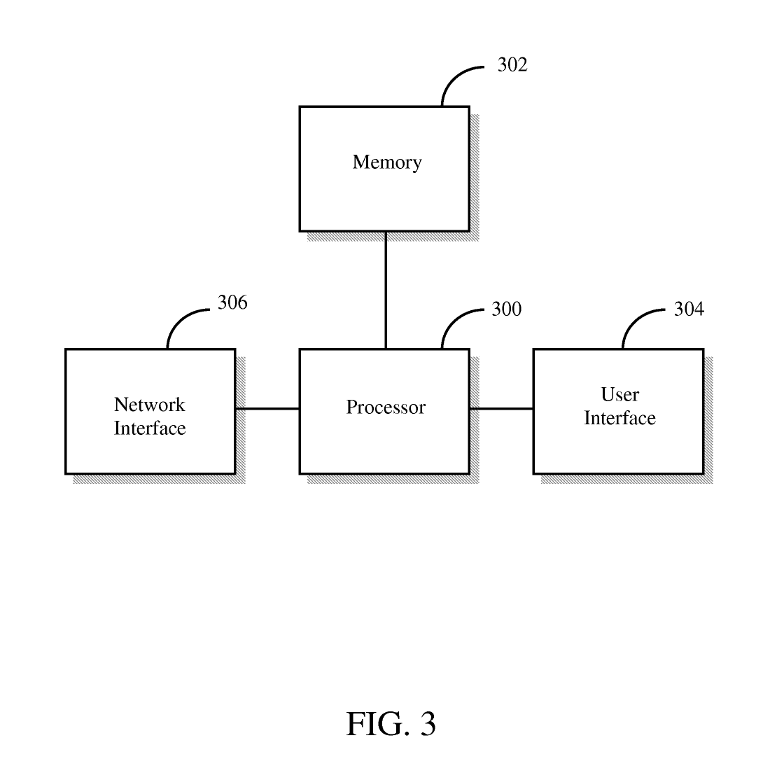

FIG. 3 is a functional block diagram illustrating one embodiment of server 108, comprising processor 300, memory 302, user interface 304, and network interface 306. It should be understood that not all of the functional blocks shown in FIG. 3 are required for operation of server 108, that the functional blocks may be connected to one another in a variety of ways, and that not all functional blocks necessary for operation of server 108 are shown (such as a power supply), for purposes of clarity.

Processor 300 is configured to provide general operation of server 108 by executing processor-executable instructions stored in memory 302, for example, executable code. Processor 300 typically comprises a general purpose processor, although any one or more of a variety of microprocessors, microcomputers, custom ASICs, discrete components, and/or microcontrollers may be used alternatively.

Memory 302 comprises one or more information storage devices, such as RAM, ROM, EEPROM, UVPROM, flash memory, CD, DVD, Memory Stick, SD memory, XD memory, thumb drive, or virtually any other type of electronic, optical, or mechanical memory device. Memory 302 is used to store the processor-executable instructions for operation of server 108 as well as any information used by processor 300. For example, the processor-executable instructions may comprise instructions for server 108 to receive information requests from one or more wireless communication devices 106, each information request relating to a particular consumer product. The instructions may further comprise instructions for authenticating a consumer product in response to receiving the information request, registering consumer product purchases, providing registration information, and/or providing enhanced product information to a requesting wireless communication device 106. The instructions may further comprise instructions for storing information pertaining to particular consumer products, or information pertaining in general to a type of consumer product, in memory 302, such as a date that a particular consumer product was manufactured, series information relating to the total number of similar products manufactured or sold, a particular product's number in the series, a visual representation of the product (i.e., a digital image of the product, a video of the product), a visual representation of people, places, or things related to the product, such as a video showing places of interest in a city where the product was manufactured, or where the headquarters of the product is located, a video of a celebrity wearing or using the product), a list of celebrities who have previously authenticated/registered the product, information related to similar products (e.g., description of similar items, price, location, etc), a description of similar products that others have purchased, one or more visual examples of the product used in conjunction with related products (e.g., if the product is shoes, providing an image or video of a model wearing the shoes plus pants and shirt selected to coordinate with the shoes), future notices related to the product (such as a recall, the availability of a new style, the availability of the product or a similar product at a predetermined price, etc), and other information related to either the particular product in question, or information relating to the product in general.

User interface 304 is coupled to processor 300 and allows a user to operate server 108, for example to install or update software stored in memory 302 or to access data stored in memory 302. User interface 304 may comprise one or more pushbuttons, switches, sensors, keypads, keyboards, and/or microphones that generate electronic signals for use by processor 300 upon initiation by a user. User interface 304 may additionally comprise one or more electronic displays, such as a touchscreen display, a seven-segment display, a cathode ray tube (CRT), a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of information to a user. Of course, the aforementioned items could be used alone or in combination with each other and other devices may be alternatively, or additionally, used.

Network interface 306 comprises circuitry that allows processor 300 to receive information requests and provide enhanced product information to wireless communication devices over one or more information networks, such as the Internet, cellular networks, etc. Such circuitry is well known in the art.

Either user interface 304, network interface 306, or both, may be used to send and retrieve information to server 108. For example, a product manufacturer may be allowed access to certain areas of memory 302 in order to provide information to server 108 pertinent to product authentication/registration and/or to provide enhanced product information related to one or more products so that it can be distributed to consumers as they authenticate/register and/or request enhanced product information. For example, a manufacturer may provide information used to authenticate products (such as a list of valid serial numbers, one or more cryptographic keys, etc.), a date that one or more products were produced, series information relating to a total number of products manufactured or sold, a particular product's number in the series, a visual representation of the product (i.e., a digital image of the product, a video of the product), a visual representation of people, places, or things related to the product, such as a video showing places of interest in a city where the product was manufactured, or where the headquarters of the product is located, a video of a celebrity wearing or using the product), a list of celebrities who have previously authenticated/registered the product, information related to similar products (e.g., description of similar items, price, location, etc), a description of similar products that others have purchased, one or more visual examples of the product used in conjunction with related products (e.g., if the product is shoes, providing an image or video of a model wearing the shoes plus pants and shirt selected to coordinate with the shoes), future notices related to the product (such as a recall, the availability of a new style, the availability of the product or a similar product at a predetermined price, etc), and other information related to either the particular product in question, or information relating to the product in general.

In one embodiment, enhanced product information comprises information related to products that are similar to consumer product 102. For example, memory 302 may store information pertaining to identical or similar products as the one identified in an information request. In this way, consumers may use server 108 to compare similar products prior to purchasing a particular product. Such enhanced product information may comprise a description or visual image/video of a product that is similar in type, size, color, price, or other product attribute and perhaps a location, website, telephone number, and/or address associated with a merchant who is offering the same/similar product. The enhanced information may be obtained by server 108 as information requests are received. In this case, a consumer product 102 is identified from the information request, and then an Internet search is conducted by processor 108 using product attributes that are also included in the information request. For example, the information request may comprise a description of a pair of Dockers® mens pants, having a model number or “style” number of 40018 having a retail price of $39.95. An Internet search for Dockers mens pants having style number 40018 may be conducted, either manually or automatically via processor 300, and then a list of results may be provided to the requestor in response to sending the information request.

In another embodiment, same/similar information may be provided to server 108 and stored in memory 302 by product manufacturers, retailers, or other entities in the supply chain pertaining to each consumer product 102 related to an entity, rather than processor 300 conducting an Internet search upon receipt of an information request. In this embodiment, an entity in the supply chain may identify a particular consumer product along with information pertaining to similar products related to the particular consumer product. For example, if the particular consumer product is a white, woman's button-up blouse, size small, a retailer of that product may associate enhanced information to this particular product, such as other sizes, colors, prices of woman's button-up blouses offered by the same source as the particular product or one or more other competitors. All of this information is received by server 108 and stored in memory 302, typically in a relational database where this information may be cross-related to information provided by others in the supply chain and/or from information requests sent by consumers.

In another embodiment, the enhanced product information comprises a description of products similar to, or the same as, the consumer product identified in the information request that other consumers have purchased in the past. In this embodiment, a particular consumer product 102 is identified in the information request, and then an Internet search is conducted, either manually or automatically by processor 300, to determine an identification of the same or similar products that have been sold to other consumers. This information is generally available online. A list of same and/or similar products, visual images of these products, product descriptions, prices, number of same/similar products sold, etc., may then be provided by server 108 in response to receiving the information request. In another embodiment, this information may be provided to server 108 and stored in memory 302 by product manufacturers, retailers, or other entities in the supply chain in a similar manner as described above with respect to same/similar information related to consumer product 102.

In yet another embodiment, the enhanced product information comprises a visual image and/or video of the product in use with one or more other products. This embodiment may be useful, for example, to determine if a particular shirt is properly matched, or coordinated, with a pair of pants, or if an accessory, such as a handbag, “goes with” a particular dress and/or shoes. Information regarding such matched products is pre-stored within memory 302 and a relationship is established between/among various products. For example, a pair of blue jeans may be associated with a white shirt, black, red, and green tennis shoes, a variety of handbags, etc. If an information request is received that identifies the particular pair of blue jeans, processor 300 retrieves one or more of the products associated with the blue jeans and provides this information in response to the information request. In one embodiment, an image of a model wearing the product under consideration along with one or more combinations of products that compliments the consumer product is provided as the enhanced product information. In this embodiment, an image is created by processor 300 by combining images of one or more consumer products with an image of a model. The images are combined so that the model appears to be wearing the product and associated products. The resulting image may then be provided as the enhanced product information. In another embodiment, only an image of the products is presented as enhanced product information; an image of the products being worn by a model is not provided.

In yet another embodiment, the enhanced product information comprises future notices related to consumer product 102. Such information might comprise a recall notice, the availability of a new color, style, size, price, and/or other attribute of the consumer product and/or products similar to the consumer product. When an information request is received at server 108, processor 300 may create a record in memory 302 recording information regarding the information request, such as a make and/or model number of consumer product 102, a date and/or time that the information request was transmitted or received, one or more attributes of consumer product 102, identification information of wireless communication device 106 that transmitted the information request, a name, address, telephone number, email address of a person associated with wireless communication device 106, etc. After storing this information, processor 300 periodically performs a search, typically using the Internet, to automatically determine whether any new information exists pertaining to the consumer product that was previously registered and/or authenticated. If updated information is found, it may be automatically forwarded to wireless communication device 106 using the information stored in the record created in memory 302. In another embodiment, consumer product information may be updated by a manufacturer, retailer, wholesaler, or other entity by providing such updated information directly to server 108.

In yet another embodiment, consumers can register consumer product 102 after it has been purchased. In this embodiment, when an information request is transmitted by wireless communication device 106, processor 300 in server 108 creates a record in memory 302 comprising information in the information request, such as identification information of the consumer that transmitted the information request and information related to the consumer product being registered. At some future time, if the consumer chooses to sell the consumer product to another person, the consumer may transmit a message to server 108, using the application on wireless communication device 106, informing processor 300 that the consumer no longer owns the consumer product. Processor 300 will then allow a subsequent identification request from the new owner to register the consumer product upon receipt of an information request from the new owner.

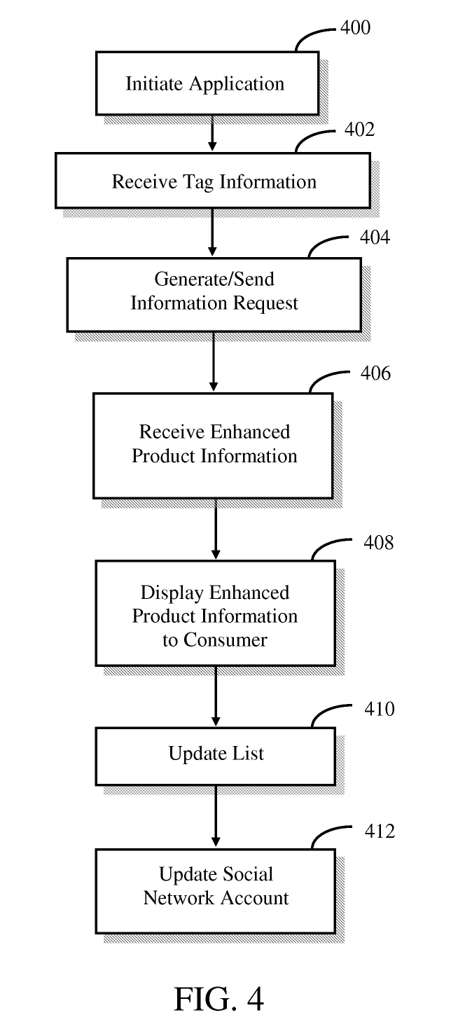

FIG. 4 is a flow diagram illustrating one embodiment of a method for providing enhanced product information to consumers. It should be understood that in some embodiments, not all of the steps shown in FIG. 4 are performed. It should also be understood that the order in which the steps are carried out may be different in other embodiments.

At block 400, a consumer and user of wireless communication device 106 initiates a software application resident within wireless communication device 106 when the consumer wishes to receive enhanced product information related to consumer product 102 that the user owns or is about to purchase. The software application typically allows the consumer to receive information from tag 104 embedded into, or onto, consumer product 102. In one embodiment, wireless communication device 106 comprises a smartphone containing reader 208 which emits a radio frequency signal that is received by tag 104. Tag 104, in response, provides information stored within tag 104 wirelessly to reader 208 using techniques well-known in the art. The information comprises information identifying consumer product 102 and/or information used to authenticate consumer product 102, such as a make and/or model number of consumer product 102, a serial number of consumer product 102, one or more attributes of consumer product 102 such as size, color, price, etc., an encrypted digital signature, an encrypted serial number, cryptographic keys, or other information well-known in the art to perform authentication. The information from tag 104 is received by reader 208 at block 402.

At block 404, processor 200 generates and sends an information request to server 108. The information request may request that consumer product 102 is authentic and/or for server 108 to provide enhanced product information to wireless communication device 106. The information request may comprise information used by server 108 to provide the requested information, such as information stored within tag 104 (such as a serial number, make and/or model number, a digital signature, encrypted information, a certificate, a description of consumer product 102, etc.), a location of consumer product 102 entered by the user or by providing a location generated by wireless communication device 106, a date of purchase, a time of purchase, a date that the request was sent, a time that the request was sent, a name of the user, a city where the user resides, information relating to a user's profile on a social network website such as Facebook, etc.

The information request is sent to server 108, where it is received and processed. If authentication of consumer product 102 was requested, server 108 authenticates consumer product 102 using the information provided in the information request.

At block 406, wireless communication device 106 receives the enhanced product information from server 108. The enhanced product information may comprise one or more of the following: an acknowledgement that consumer product 102 was successfully authenticated, an acknowledgement that consumer product 102 was successfully registered, a date that a particular consumer product was manufactured, shipped, sold, etc., series information relating to the total number of the same product type manufactured or sold and a particular product's number in the series, a visual representation of the product (i.e., a digital image of the product, a video of the product), a visual representation of people, places, or things related to the product, such as a video showing places of interest in a city where the product was manufactured, or where the headquarters of the product is located, a video of a celebrity wearing or using the product), a list of celebrities who have previously authenticated/registered the product, information related to similar products (e.g., description of similar items, price, location, etc), a description of similar products that others have purchased, one or more visual examples of the product used in conjunction with related products (e.g., if the product is shoes, providing an image or video of a model wearing the shoes plus pants and shirt selected to coordinate with the shoes), future notices related to the product (such as a recall, the availability of a new style, the availability of the product or a similar product at a predetermined price, etc), and other information related to either the particular product in question, or information relating to the product in general.

At block 408, the enhanced product information may be displayed to the user via user interface 204.

At block 410, a list of consumer products that the consumer has previously authenticated and/or registered is updated with enhanced product information received at block 406. In one embodiment, the list may allow the consumer to conveniently re-order consumer product 102.

At block 412, the software application resident on wireless communication device 106 may query the consumer whether he or she would like to update a social network, such as Facebook, MySpace, Twitter, etc., account belonging to the user. For example, the update may comprise posting a “Like” message indicating that the consumer has authenticated and/or registered consumer product 102 and that the consumer endorses the manufacturer, retailer, or other supply chain entity. In another example, the update may comprise a posting on Twitter endorsing consumer product 102 and/or a manufacturer, retailer, or other supply chain entity associated with consumer product 102. The software application may query the consumer for a username and password and then automatically provide the update upon receipt of the information from the consumer. In another embodiment, processor 300 may query the consumer for a short narrative regarding consumer product 102, and then update the consumer's social network account using the narrative.

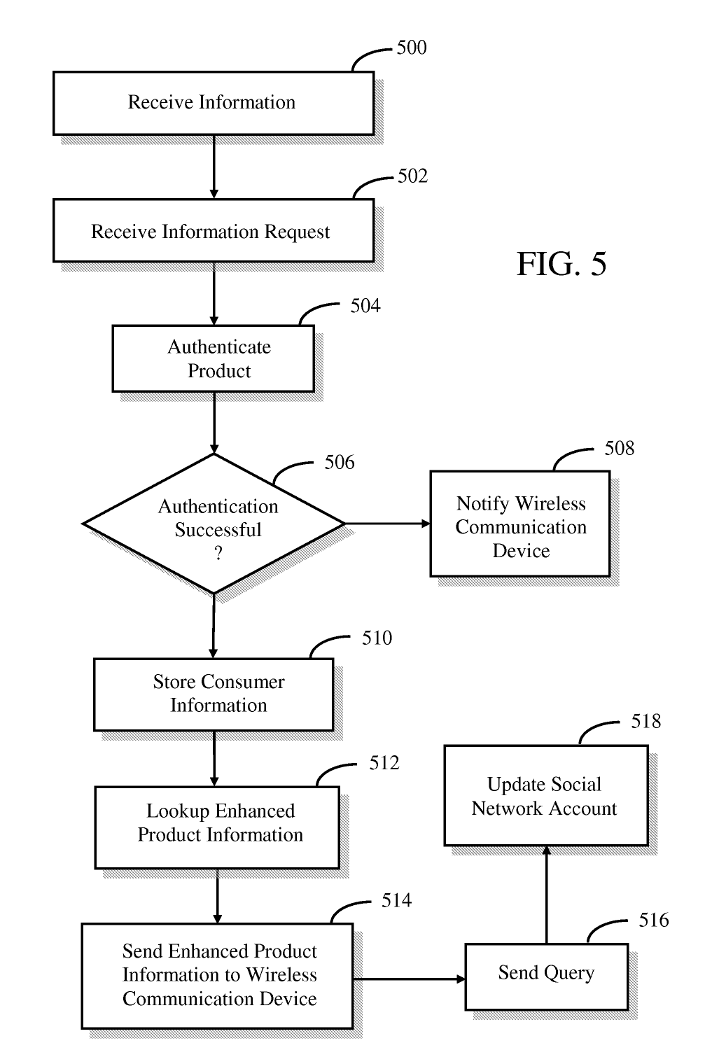

FIG. 5 is a flow diagram illustrating another embodiment of a method for providing enhanced product information to consumers, implemented by server 108. It should be understood that in some embodiments, not all of the steps shown in FIG. 5 are performed. It should also be understood that the order in which the steps are carried out may be different in other embodiments.

At block 500, server 108 receives information from a retailer, manufacturer, wholesaler, or other entity in the supply chain related to consumer product 102. This information may be used to authenticate consumer product 102 as being genuine before or after a consumer purchases consumer product 102. For example, a valid serial number associated with consumer product 102, a digital signature associated with tag 104, etc. Other information may be provided as well, such as a date that consumer product 102 was manufactured, shipped, sold, etc., series information relating to the total number of the same product type manufactured or sold and consumer product 102's number in the series, a visual representation of consumer product 102 (i.e., a digital image of consumer product 102, a video of consumer product 102), a visual representation of people, places, or things related to consumer product 102, such as a video showing places of interest in a city where consumer product 102 was manufactured, or where the headquarters of manufacturer or designer of consumer product 102 is located, a video of a celebrity wearing or using consumer product 102), a list of celebrities who have previously authenticated/registered consumer product 102, information related to products similar to consumer product 102 (e.g., description of similar items, price, location, etc), a description of similar products that others have purchased, one or more visual examples of consumer product 102 used in conjunction with related products (e.g., if consumer product 102 comprises a pair of shoes, providing an image or video of a model wearing the shoes plus pants and shirt selected to coordinate with the shoes), future notices related to consumer product 102 (such as a recall, the availability of a new style, the availability of the product or a similar product at a predetermined price, etc), and other information related to either consumer product 102, or information relating, in general, to consumer product 102.

At block 502, server 108 receives an information request from a wireless communication device 106. The information request is sent by wireless communication device 106 on behalf of a consumer to request enhanced consumer product information, comprising a request to authenticate consumer product 102 (either before or after purchasing consumer product 102), a request to register consumer product 102, and/or to provide additional product information related to consumer product 102. The information request may comprise information used by server 108 to provide the requested information, such as information stored within tag 104 (such as a serial number, a digital signature, encrypted information, a certificate, a description of consumer product 102, etc.), a location of consumer product 102 entered by the user or by providing a location generated by wireless communication device 106, a date of purchase, a time of purchase, a date that the request was sent, a time that the request was sent, a name of the user, a city where the user resides, information relating to a user's profile on a social network website such as Facebook, etc.

At block 504, processor 300 may perform an authentication procedure by comparing information supplied in the information request to authentication information received at block 500 and stored in memory 302. For example, the information supplied in the information request may comprise an encrypted serial number and the authentication information stored in memory 302 could comprise a list of valid serial numbers assigned to authentic products manufactured by, or for, one or more retailers, manufactures, vendors, suppliers, or other such source of consumer products. If a match is found between information supplied in the information request and memory 302, consumer product 102 is deemed to be authentic, and processing continues to block 510. If no match is found, processing continues to block 508, where a notification is generated and sent to wireless communication device 106 indicating that consumer product 102 is not genuine.

At block 510, processor 300 may store some or all of the information that was received in the information request into memory 302. In one embodiment, a record is updated that reflects a total number of information requests received for a particular product or product model or type, and/or a list of celebrities who have requested enhanced information for a particular consumer product. Other information that may be stored include a name of a person associated with each information request, a location associated with each information request (such as a location where consumer product 102 is presently located, the city or state of residence of the person requesting the information, etc.), a serial number associated with consumer product 102, and/or information pertaining to consumer product, such as the color, size, etc., of consumer product 102, an identification of wireless communication device 106, etc.

At block 512, processor 300 retrieves enhanced consumer product information from memory 302 pertaining to consumer product 102. For example, the enhanced product information may comprise one or more of the following: an acknowledgement that consumer product 102 was successfully authenticated, an acknowledgement that consumer product 102 was successfully registered, a date that consumer product 102 was manufactured, series information relating to the total number of similar products manufactured or sold, the particular consumer product 102's number in the series, a visual representation of consumer product 102, a list of celebrities who have previously requested enhanced information regarding the consumer product in general, and other information related to either the particular product being authenticated, or information relating to the product in general. Typically, processor 300 uses information pertaining to consumer product 102 to select which information to provide in response to the information request. For example, if the information request identified a pair of Nike Air Jordan athletic shoes, processor 300 would use this information to search memory 302 for information pertaining to that particular type of consumer product. If enhanced product information pertaining to Nike Air Jordan athletic shoes was found, that information would be sent to the particular requesting wireless communication device 106 at block 514.

At block 516, processor 300 may generate a message that is sent to wireless communication device 106 querying the consumer associated with wireless communication device 106 whether he or she would like to update a social network, such as Facebook, MySpace, Twitter, etc., account belonging to the user. For example, the update may comprise posting a “Like” message indicating that the consumer has authenticated and/or registered consumer product 102 and that the consumer endorses the manufacturer, retailer, or other supply chain entity. In another example, the update may comprise a posting on Twitter endorsing consumer product 102 and/or a manufacturer, retailer, or other supply chain entity associated with consumer product 102. The message generated by processor 300 may include a query for a username and password associated with the consumer's social network account. An update to the consumer's social network account may be performed automatically by processor 300 after receipt of the username and password from the consumer. In another embodiment, processor 300 may query the consumer for a short narrative regarding consumer product 102, and then update the consumer's social network account using the narrative.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A method for providing enhanced product information of a consumer product, comprising:
receiving consumer product identification information relating to the consumer product from an electronic tag co-located with the consumer product;
sending an information request to a remote server, the information request comprising the consumer product identification information;
receiving the enhanced product information from the remote server, the enhanced product information comprising information relating to the consumer product; and
displaying the enhanced product information on an electronic display.

2. The method of claim 1, wherein the enhanced product information comprises a total number of the particular type of consumer product manufactured and a number indicating which one of the total number that the particular consumer product represents.

3. The method of claim 1, wherein the enhanced product information comprises an indication that the consumer product is authentic.

4. The method of claim 1, further comprising:
updating a list of other consumer products that have been purchased to include a description of the consumer product.

5. The method of claim 1, wherein the enhanced product information comprises a date that the consumer product was manufactured.

6. The method of claim 1, wherein the enhanced product information comprises a visual indication of the consumer product.

7. The method of claim 1, wherein the enhanced product information comprises a list of celebrities each who have previously requested enhanced product information of a similar consumer product.

8. The method of claim 1, wherein the enhanced product information comprises a number of people who have previously requested enhanced product information of a similar consumer product.

9. The method of claim 1, wherein the enhanced product information comprises information related to products that are similar to the consumer product.

10. The method of claim 1, wherein the enhanced product information comprises a description of products similar to the consumer product that other consumers have purchased.

11. The method of claim 1, wherein the enhanced product information comprises one or more visual examples of the consumer product used in conjunction with related consumer products.

12. The method of claim 11, wherein the one or more visual examples comprises an image of a model wearing clothing that compliments the consumer product.

13. The method of claim 1, wherein the enhanced product information comprises a future notice related to the product.

14. The method of claim 3, further comprising:
updating a social network account associated with an individual associated with the consumer product to indicate that the individual has purchased an authentic consumer product.

15. The method of claim 14, wherein updating the social network account comprises displaying a “Like” notification pertaining to the consumer product.

16. The method of claim 14, wherein updating the social network account comprises displaying a “Like” notification pertaining to a manufacturer of the consumer product.

17. An apparatus for providing enhanced product information of a consumer product, comprising:
a receiver for receiving consumer product identification information relating to the consumer product from an electronic tag co-located with the consumer product;
a transceiver for transmitting and receiving information;
a processor; and
a memory for storing processor-readable instructions that cause the apparatus to:
transmit an information request to a remote server using the transceiver, the information request comprising the consumer product identification information; and
receive the enhanced product information from the remote server, the enhanced product information comprising information relating to the consumer product;
and
a user interface for displaying the enhanced product information.

18. The apparatus of claim 17, wherein the enhanced product information comprises a total number of the particular type of consumer product manufactured and a number indicating which one of the total number that the particular consumer product represents.

19. The apparatus of claim 17, wherein the enhanced product information comprises an indication that the consumer product is authentic.

20. The apparatus of claim 17, wherein the processor-readable instructions further cause the apparatus to:
update a list of other consumer products that have been purchased to include a description of the consumer product.

21. The apparatus of claim 17, wherein the enhanced product information comprises a date that the consumer product was manufactured.

22. The apparatus of claim 17, wherein the enhanced product information comprises a visual indication of the consumer product.

23. The apparatus of claim 17, wherein the enhanced product information comprises a list of celebrities each who have previously requested enhanced product information of a similar consumer product.

24. The apparatus of claim 17, wherein the enhanced product information comprises a number of people who have previously requested enhanced product information of a similar consumer product.

25. The apparatus of claim 17, further comprising instructions for the apparatus to:
update a social network account associated with an individual associated with the consumer product to indicate that the individual has purchased an authentic consumer product.

26. The apparatus of claim 25, wherein updating the social network account comprises displaying a “Like” notification pertaining to the consumer product.

27. The apparatus of claim 25, wherein updating the social network account comprises displaying a “Like” notification pertaining to a manufacturer of the consumer product.

28. The apparatus of claim 17, wherein the enhanced product information comprises information related to products that are similar to the consumer product.

29. The apparatus of claim 17, wherein the enhanced product information comprises a description of products similar to the consumer product that other consumers have purchased.

30. The apparatus of claim 17, wherein the enhanced product information comprises one or more visual examples of the consumer product used in conjunction with related consumer products.

31. The apparatus of claim 30, wherein the one or more visual examples comprises an image of a model wearing clothing that compliments the consumer product.

32. The apparatus of claim 17, wherein the enhanced product information comprises a future notice related to the product.

33. A method for providing enhanced product information of a consumer product, comprising:
receiving the enhanced product information from a source of the consumer product;
storing the enhanced product information in a memory;
receiving an information request from a wireless communication device, the information request comprising consumer product identification information relating to the consumer product, the consumer product identification information provided by an electronic tag co-located with the consumer product;
comparing the consumer product identification information to the enhanced product information stored in the memory; and
sending the enhanced product information to the wireless communication device if a match if found between the consumer product identification information and the enhanced product information.

34. The method of claim 33, wherein the enhanced product information comprises a total number of the particular type of consumer product manufactured and a number indicating which one of the total number that the particular consumer product represents.

35. The method of claim 33, wherein the enhanced product information comprises a date that the consumer product was manufactured.

36. The method of claim 33, wherein the enhanced product information comprises a visual indication of the consumer product.

37. The method of claim 33, further comprising:
storing a list of celebrity names in the memory; and
receiving a second information request relating to a second consumer product from a second wireless communication device, the second consumer product comprising a similar consumer product type as the consumer product, the second information request comprising an identification of a person sending the second information request;
comparing the identification of the person to a list of celebrities;
wherein the enhanced product information comprises the identification of the person if the identification matches one of the celebrity names stored in the list of celebrity names.

38. An apparatus for providing enhanced product information of a consumer product, comprising:
a network interface for sending and receiving information;
a processor;
a memory for storing the enhanced product information and processor-readable instructions that cause the apparatus to:
receive an information request from a wireless communication device, the information request comprising consumer product identification information relating to the consumer product, the consumer product identification information provided by an electronic tag co-located with the consumer product;
compare the consumer product identification information to the enhanced product information stored in the memory; and
send the enhanced product information to the wireless communication device if a match if found between the consumer product identification information and the enhanced product information.

39. The apparatus of claim 37, wherein:
the memory further stores a list of celebrity names further instructions to cause the apparatus to;
receive a second information request relating to a second consumer product from a second wireless communication device, the second consumer product comprising a similar consumer product type as the consumer product, the second information request comprising an identification of a person sending the second information request; and
compare the identification of the person to a list of celebrities;
wherein the enhanced product information comprises the identification of the person if the identification matches one of the celebrity names stored in the list of celebrity names.
